(19) United States
(12) Patent Application Publication
(10) Pub. No.: US 2016/0329591 A1
(43) Pub. Date: Nov. 10, 2016

(54) MEMBRANE-ELECTRODE ASSEMBLY MANUFACTURING APPARATUS OF FUEL CELL

(71) Applicant: Hyundai Motor Company, Seoul (KR)

(72) Inventor: Sun Ho Lee, Seoul (KR)

(21) Appl. No.: 14/921,859

(22) Filed: Oct. 23, 2015

(30) Foreign Application Priority Data
May 8, 2015 (KR) 10-2015-0064756

(51) Int. Cl. H01M 8/24; H01M 8/00; H01M 8/10

(52) U.S. Cl. CPC H01M 8/248; H01M 8/1004; H01M 8/006

(57) ABSTRACT

A membrane-electrode assembly manufacturing apparatus of a fuel cell is provided and includes a loading apparatus for stacking a first gas diffusion layer, a membrane-electrode assembly, and a second gas diffusion layer on a lower feeding belt. An upper hot roller and a lower hot roller are disposed for pressing a stack unit that includes the first gas diffusion layer, the membrane-electrode assembly, and the second gas diffusion layer stacked at set temperatures and pressures. An upper input roller and a lower input roller disposed at an inlet side of the upper hot roller and the lower hot roller supply the stack unit between the upper and lower hot roller. An upper output roller and a lower output roller disposed at an outlet side of the upper hot roller and the lower hot roller draw out the stack unit between the upper and hot roller.

### CROSS-REFERENCE TO RELATED APPLICATION

This application claims priority to and the benefit of Korean Patent Application No. 10-2015-0064756 filed in the Korean Intellectual Property Office on May 8, 2015, the entire contents of which are incorporated herein by reference.

### BACKGROUND

(a) Field of the Invention

The present invention relates to a system for manufacturing fuel cell stack components and more particularly, to a membrane-electrode assembly manufacturing apparatus for manufacturing a membrane-electrode assembly (MEA) of a fuel cell.

(b) Description of the Related Art

Generally, a fuel cell produces electricity via an electrochemical reaction between hydrogen and oxygen. The fuel cell generates electricity by receiving a chemical reactant from an external source without a separate charging process. The fuel cell includes separators (e.g., separating plates or bipolar plates) disposed at opposing (e.g., both) sides of a membrane-electrode assembly. A plurality of fuel cells are continuously arranged to form a fuel cell stack. In particular, a main component of a fuel cell includes a membrane-electrode assembly configured to include a hydrogen electrode and an air electrode as electrode catalyst layers formed at opposing sides of an electrolyte membrane in which hydrogen ions are moved. Additionally, the membrane-electrode assembly includes a sub gasket to protect the electrode catalyst layer and the electrolyte membrane and ensures the assembling property of the fuel cell.

Further, during manufacturing of the membrane-electrode assembly, an electrode membrane sheet is prepared via a decal method for unwinding an electrolyte membrane wound in a roll form. The electrode cathode layers to be spaced apart from each other with a predetermined interval (e.g., a pitch of about 150 mm) on opposing surfaces of the electrolyte membrane are continuously transferred. Then, a membrane-electrode assembly sheet is manufactured by performing a roll-to-roll as a backend process for unwinding and moving the electrode membrane sheet wound in a roll form. For example, the sub gasket is unwound from a roll form and positioned on opposing surfaces of the electrode membrane sheet. The resulting structure is then passed through a hot roller, causing the sub gasket to adhere to the opposing surfaces of the electrode membrane sheet.

Consequently, a fuel cell is manufactured by adhering (e.g., bonding) a membrane-electrode assembly (MEA) and a gas diffusion layer (GDL) to each other at a high temperature and alternately stacking the adhered structure and the separating plate. Typically, a hot roller adhering process for pressing the structure at a predetermined high pressure and heating the structure with a predetermined high temperature are used to adhere the membrane-electrode assembly and the gas diffusion layer. However, when a glass fiber belt is used during the hot roller adhering process, the glass fiber and the gas diffusion layer may become entangled. Namely, the gas diffusion layer separates from the membrane-electrode assembly, and an adhering failure may occur at a belt joint.

The above information disclosed in this section is merely for enhancement of understanding of the background of the invention and therefore it may contain information that does not form the prior art that is already known in this country to a person of ordinary skill in the art.

### SUMMARY

The present invention exemplary embodiment provides a membrane-electrode assembly manufacturing apparatus that reduces manufacturing costs by preventing a gas diffusion layer and a membrane-electrode assembly from separating using a glass fiber belt when the gas diffusion layer and the membrane-electrode assembly are adhered at a predetermined temperature condition and a predetermined pressure.

An exemplary embodiment provides a membrane-electrode assembly manufacturing apparatus that may include a loading apparatus for sequentially stacking a first gas diffusion layer, a membrane-electrode assembly, and a second gas diffusion layer on a lower feeding belt. The apparatus may further include an upper hot roller and a lower hot roller that may be disposed for pressing a stack unit including the first gas diffusion layer, the membrane-electrode assembly, and the second gas diffusion layer stacked therein at a set temperature and a set pressure. An upper input roller and a lower input roller may be disposed at an inlet side of the upper hot roller and the lower hot roller to supply the stack unit between the upper hot roller and the lower hot roller. An upper output roller and a lower output roller may be disposed at an inlet side of the upper hot roller and the lower hot roller to draw out the stack unit between the upper hot roller and the lower hot roller.

In some exemplary embodiments, the membrane-electrode assembly manufacturing apparatus may further include a vacuum adsorption conveyor that may be disposed to support a lower portion of the lower feeding belt prior to entrance toward the upper feeding roller and the lower feeding roller. In other exemplary embodiments, the lower feeding belt may pass on the vacuum adsorption conveyor, the upper input roller, and the lower input roller, may pass below the lower hot roller, and may pass between the upper output roller and the lower output roller, and may circulate on the vacuum adsorption conveyor.

Additionally, the membrane-electrode assembly manufacturing apparatus may include a lower guide roller to guide the lower feeding belt disposed below (e.g., beneath) the lower input roller and the lower output roller to pass below (e.g., beneath) the lower hot roller. The membrane-electrode assembly manufacturing apparatus may further include an upper guide roller disposed on the upper hot roller, and an upper feeding belt that may pass between the lower input roller and the upper input roller and may circulate along the upper guide roller and between the upper output roller and the lower output roller. The membrane-electrode assembly manufacturing apparatus may further include a component support plate disposed between the lower input roller and the lower hot roller to support the stack unit input between the lower hot roller and the upper hot roller to prevent the stack unit from being separated.

In an exemplary embodiment, the membrane-electrode assembly manufacturing apparatus may further include a hot roll cleaner disposed extraneous to the upper hot roller or the lower hot roller to remove foreign materials attached to the upper hot roller or the lower hot roller. The membrane-electrode assembly manufacturing apparatus may further include a belt cleaner disposed extraneous to the upper feeding belt or the lower feeding belt to remove foreign materials attached to the upper feeding belt or the lower feeding belt. The hot roller cleaner or the belt cleaner may be a brush type cleaner or a magnet type cleaner.

Further, a static electricity generator for generating static electricity in the lower feeding belt may be disposed before the first gas diffusion layer is disposed on the lower feeding belt. The membrane-electrode assembly manufacturing apparatus may further include a belt alignment apparatus disposed below (e.g., beneath) the vacuum adsorption conveyor to guide the movement of the lower feeding belt. In an exemplary embodiment, the loading apparatus may further include an edge detector configured to detect exterior edges of the first and second gas diffusion layers and a reaction surface edge of the membrane-electrode assembly. The loading apparatus maybe configured to stack the first and second gas diffusion layers and the membrane-electrode assembly to align the exterior edge and the reaction surface edge.

In an exemplary embodiment, the stack unit in which the gas diffusion layer and the membrane-electrode assembly are stacked may be heated and pressed by the upper hot roller and the lower hot roller, and thus the stack unit may not be contaminated by the upper feeding belt and the lower feeding belt. In particular, the stack unit may be input directly between the upper hot roller and the lower hot roller to prevent the gas diffusion layer from being separated from the membrane-electrode assembly by a belt. The component support plate may prevent the stack unit from being separated downward and may remove foreign materials to prevent the foreign materials from being attached to the membrane-electrode assembly or the gas diffusion layer. Additionally, the static electricity generator may be configured to generate static electricity in the lower feeding belt and facilitate stable fixation of the gas diffusion layer or the membrane-electrode assembly onto the lower feeding belt.

### BRIEF DESCRIPTION OF THE DRAWINGS

The above and other features of the present disclosure will be apparent from the following detailed description taken in conjunction with the accompanying drawing.

FIG. 1 is an exemplary schematic diagram a conveyor type of membrane-electrode assembly manufacturing apparatus according to an exemplary embodiment of the present invention;

FIG. 2 is an exemplary schematic view of a membrane-electrode assembly and a gas diffusion layer according to an exemplary embodiment of the present invention; and

FIG. 3 is an exemplary schematic view of a membrane-electrode assembly and a gas diffusion layer according to an exemplary embodiment of the present invention.

### DETAILED DESCRIPTION

Advantages and features of the invention and methods of accomplishing the same may be understood more readily by reference to the following detailed description of exemplary embodiments and the accompanying drawing. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. For example, in order to make the description of the present invention clear, unrelated parts are not shown and, the thicknesses of layers and regions are exaggerated for clarity. Further, when it is stated that a layer is “on” another layer or substrate, the layer may be directly on another layer or substrate or a third layer may be disposed therebetween.

To clearly describe the present invention, a part without concerning to the description is omitted and the same or like reference numerals in the specification denote the same or like elements. Sizes and thicknesses of the elements shown in the drawings are for the purpose of descriptive convenience, and thus the present invention is not necessarily limited thereto and a thickness is enlarged to clarify various parts and regions. Terms such as first, second, etc. may be used to describe various elements, but these terms do not limit elements and are used only to classify one element from another.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

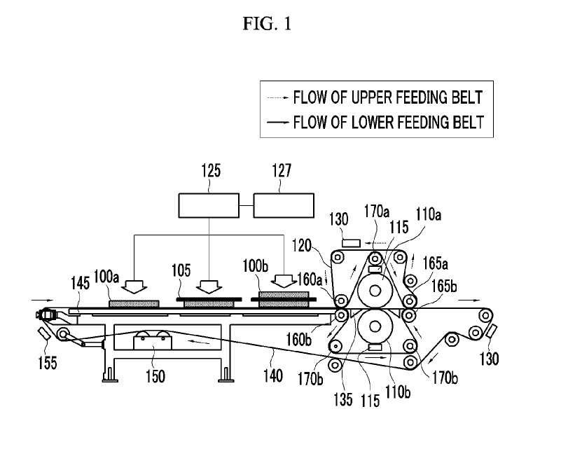

FIG. 1 is an exemplary schematic diagram a conveyor type of membrane-electrode assembly manufacturing apparatus according to an exemplary embodiment. Referring to

FIG. 1, the conveyor type of membrane-electrode assembly may include first and second gas diffusion layers 100a and 100b, a membrane-electrode assembly 105, a robot 125, an edge detector 127, a lower input roller 160b, an upper input roller 160a, a belt cleaner 130, an upper feeding belt 120, an upper guide roller 170a, a hot roller cleaner 115, an upper hot roller 110a, a component support plate 135, an upper output roller 165a, a lower output roller 165b, a lower hot roller 110b, a lower guide roller 170b, a lower feeding belt 140, a belt alignment apparatus 150, a static electricity generator 155, and a vacuum adsorption conveyor 145.

The lower feeding belt 140 may be configured to move on the vacuum adsorption conveyor 145, and the first gas diffusion layer 100a, the membrane-electrode assembly 105, and the second gas diffusion layer 100b may be sequentially stacked on the lower feeding belt 140 by the robot 125. The upper input roller 160a and the lower input roller 160b may be disposed at upper and lower portions of an outlet side of the vacuum adsorption conveyor 145, and the upper hot roller 110a and the lower hot roller 110b may be disposed at upper and lower portions behind (e.g., beneath) the upper input roller 160a and the lower input roller 160b.

Additionally, the upper output roller 165a and the lower output roller 165b may be disposed at upper and lower portions behind (e.g., beneath or distal to) the upper hot roller 110a and the lower hot roller 110b. The upper guide roller 170a may be disposed on the upper hot roller 110a and the lower guide roller 170b may be disposed below (e.g., underneath) the lower hot roller 110b. The upper feeding belt 120 may be configured to circulate along the upper input roller 160a, the upper guide roller 170a, and the upper output roller 165a and may not pass between the upper hot roller 110a and the lower hot roller 110b.

Further, the lower feeding belt 140 may be configured to circulate along the vacuum adsorption conveyor 145, the lower input roller 160b, the lower guide roller 170b and the lower output roller 165b and may not pass between the upper hot roller 110a and the lower hot roller 110b. The belt cleaner 130 may be disposed on an external (e.g., exterior) side of each of the upper feeding belt 120 and the lower feeding belt 140, and may remove foreign materials attached onto a belt, and may be a brush type cleaner or a magnet type cleaner that may generate magnetism.

The belt alignment apparatus 150 for preventing irregular movement (e.g., zigzag driving) of the lower feeding belt 140 may be disposed below (e.g., distal to) the vacuum adsorption conveyor 145, and the static electricity generator 155 for generating static electricity in the lower feeding belt 140 may be disposed in front of (e.g. proximal to) the vacuum adsorption conveyor 145. The static electricity produced in the lower feeding belt 140 by the static electricity generator 155 may improve adhesion of the first gas diffusion layer 100a to the lower feeding belt 140, and may thereby improve the stability of the process and may reduce the vacuum adsorption load of the vacuum adsorption conveyor 145.

The component support plate 135 may be disposed between the lower input roller 160b and the lower hot roller 110b and between the lower output roller 165b and the lower hot roller 110b, respectively. Further, the component support plate 135 may prevent downward separation of a stack unit in which the first gas diffusion layer 100a, the membrane-electrode assembly 105, and the second gas diffusion layer 100b are stacked. The hot roller cleaner 115 may be disposed on an external side (e.g., exterior side) of each of the upper hot roller 110a and the lower hot roller 110b, and may remove foreign materials attached onto a roller. The hot roller cleaner may be a brush type cleaner or a magnet type cleaner that may generate magnetism.

In an exemplary embodiment, the edge detector 127 may be configured to detect exterior edges 205 of the first and second gas diffusion layers 100a and 100b and a reaction surface edge 205 of the membrane-electrode assembly 105. The first and second gas diffusion layers 100a and 100b and the membrane-electrode assembly 105 may be sequentially stacked on the lower feeding belt 140 to align the exterior edge 205 and the reaction surface edge 205.

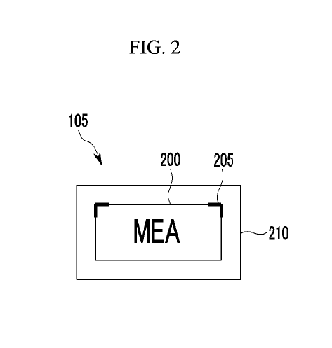

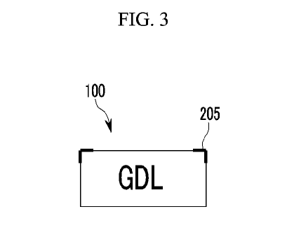

FIGS. 2 and 3 are exemplary schematic views of a membrane-electrode assembly 105 and a gas diffusion layer 100 according to an exemplary embodiment of the present invention. Referring to FIGS. 2 and 3, the membrane-electrode assembly 105 may include a reaction surface 200 at a central portion, a reaction surface edge 205 formed at an edge of the reaction surface 200, and a sub gasket 210. The edge detector 127 may be configured to detect the reaction surface edge 205 of the reaction surface 200 of the membrane-electrode assembly 105. Additionally, the edge detector 127 may be configured to detect the exterior edge 205 of the gas diffusion layer 100, and the robot 125 may be configured to stack the gas diffusion layer 100 and the membrane-electrode assembly 105 to align the exterior edge 205 of the gas diffusion layer 100 and the reaction surface edge 205 of the membrane-electrode assembly 105. The robot 125 may be operated by a controller having a processor and a memory.

In an exemplary embodiment, the stack unit in which the gas diffusion layer 100 and the membrane-electrode assembly 105 are stacked may be heated (e.g., directly heated) and pressed by the upper hot roller 110a and the lower hot roller 110b. For example, the stack unit may be prevented from being contaminated by the upper feeding belt 120 and the lower feeding belt 140. In particular, when the upper feeding belt 120 or the lower feeding belt 140 causing glass fiber, the glass fiber and the gas diffusion layer 100 may be entangled and may separate the gas diffusion layer 100 from the membrane-electrode assembly 105. However, according to an exemplary embodiment, the stack unit may be input (e.g., directly) between the upper hot roller 110a and the lower hot roller 110b to prevent the gas diffusion layer 100 from being separated from the membrane-electrode assembly 105.

Furthermore, the component support plate 135 may be disposed between the lower input roller 160b and the lower hot roller 110b and between the lower hot roller 110b and the lower output roller 165b, respectively. Namely, to prevent the stack unit from being separated downward, the hot roller cleaner 115 and the belt cleaner 130 may remove foreign materials to prevent the foreign materials from being attached to the membrane-electrode assembly 105 or the gas diffusion layer 100. The static electricity generator 155 may be configured to generate static electricity in the lower feeding belt 140 and may facilitate stable fixation of the gas diffusion layer 100 or the membrane-electrode assembly 105 onto the lower feeding belt 140.

While this invention has been described in connection with what is presently considered to be exemplary embodiments, on the contrary, is intended to cover various modifications and equivalent arrangements included within the spirit and scope of the appended claims. In addition, it is to be considered that all of these modifications and alterations fall within the scope of the present invention.

### DESCRIPTION OF SYMBOLS

100a: first gas diffusion layer
100b: second gas diffusion layer
100: gas diffusion layer
105: membrane-electrode assembly
110a: upper hot roller
110b: lower hot roller
115: hot roller cleaner
120: upper feeding belt
125: robot
127: edge detector
130: belt cleaner
135: component support plate
140: lower feeding belt
145: vacuum adsorption conveyor
150: belt alignment apparatus
155: static electricity generator
160a: upper input roller
165a: upper output roller
165b: lower output roller
160b: lower input roller
170a: upper guide roller
170b: lower guide roller
200: reaction surface
205: edge
210: sub gasket

What is claimed is:

1. A membrane-electrode assembly manufacturing apparatus of a fuel cell, comprising:
a loading apparatus for stacking a first gas diffusion layer, a membrane-electrode assembly, and a second gas diffusion layer on a lower feeding belt;
an upper hot roller and a lower hot roller disposed for pressing a stack unit including the first gas diffusion layer, the membrane-electrode assembly, and the second gas diffusion layer stacked therein at a set temperature and a set pressure;

2. The membrane-electrode assembly manufacturing apparatus of claim 1, further comprising:
an upper input roller and a lower input roller disposed at an inlet side of the upper hot roller and the lower hot roller to supply the stack unit between the upper hot roller and the lower hot roller; and
an upper output roller and a lower output roller disposed at an outlet side of the upper hot roller and the lower hot roller to draw out the stack unit between the upper hot roller and the lower hot roller.

3. The membrane-electrode assembly manufacturing apparatus of claim 2, further comprising:
a vacuum adsorption conveyor disposed to support a lower portion of the lower feeding belt prior to entrance toward the upper feeding roller and the lower feeding roller.

4. The membrane-electrode assembly manufacturing apparatus of claim 3, wherein:
the lower feeding belt passes on the vacuum adsorption conveyor, the upper input roller, and the lower input roller, passes below the lower hot roller, and passes between the upper output roller and the lower output roller, and circulates on the vacuum adsorption conveyor.

5. The membrane-electrode assembly manufacturing apparatus of claim 4, further comprising:
a lower guide roller configured to guide the lower feeding belt disposed below the lower input roller and the lower output roller to pass below the lower hot roller.

6. The membrane-electrode assembly manufacturing apparatus of claim 2, further comprising:
an upper guide roller disposed on the upper hot roller; and
an upper feeding belt passing between the lower input roller and the upper input roller and circulating along the upper guide roller and disposed between the upper output roller and the lower output roller.

7. The membrane-electrode assembly manufacturing apparatus of claim 2, further comprising:
a component support plate disposed between the lower input roller and the lower hot roller to support the stack unit input between the lower hot roller and the upper hot roller to prevent the stack unit from being separated downward.

8. The membrane-electrode assembly manufacturing apparatus of claim 2, further comprising:
a hot roll cleaner disposed extraneous to the upper hot roller or the lower hot roller to remove foreign materials attached to the upper hot roller or the lower hot roller.

9. The membrane-electrode assembly manufacturing apparatus of claim 6, further comprising:
a belt cleaner disposed extraneous to the upper feeding belt or the lower feeding belt to remove foreign materials attached to the upper feeding belt or the lower feeding belt.

10. The membrane-electrode assembly manufacturing apparatus of claim 8, wherein: the hot roller cleaner is a brush type cleaner or a magnet type cleaner.

11. The membrane-electrode assembly manufacturing apparatus of claim 9, wherein: the belt cleaner is a brush type cleaner or a magnet type cleaner.

12. The membrane-electrode assembly manufacturing apparatus of claim 2, wherein: a static electricity generator configured to generate static electricity in the lower feeding belt is disposed before the first gas diffusion layer is disposed on the lower feeding belt.

13. The membrane-electrode assembly manufacturing apparatus of claim 3, further comprising:
a belt alignment apparatus disposed below the vacuum adsorption conveyor to guide movement of the lower feeding belt.

14. The membrane-electrode assembly manufacturing apparatus of claim 2, wherein, the loading apparatus further includes: an edge detector configured to detect exterior edges of the first and second gas diffusion layers and a reaction surface edge of the membrane-electrode assembly.

15. The membrane-electrode assembly manufacturing apparatus of claim 14, wherein, the loading apparatus stacks the first and second gas diffusion layers and the membrane-electrode assembly to align the exterior edge and the reaction surface edge.
